(19) United States
(12) Patent Application Publication
(10) Pub. No.: US 2022/0100254 A1
(43) Pub. Date: Mar. 31, 2022

(54) CONFIGURING A POWER MANAGEMENT SYSTEM USING REINFORCEMENT LEARNING

(71) Applicant: ATI TECHNOLOGIES ULC, Markham (CA)

(72) Inventor: ROBERT SZURTEI, MARKHAM (CA)

(21) Appl. No.: 17/032,372

(22) Filed: Sep. 25, 2020

(51) Int. Cl. G06F 1/3234; G06F 1/324; G06F 1/3228; G06N 3/08

(52) U.S. Cl. CPC G06F 1/3243; G06N 3/08; G06F 1/3228; G06F 1/324

(57) ABSTRACT

Configuring a power management system using reinforcement learning, including: receiving data indicating, for an execution of a workload, a plurality of performance counters, a plurality of power consumptions, and a plurality of processing frequency modification decisions, wherein the plurality of processing frequency modification decisions are generated by a neural network; calculating, based on the plurality of performance counters, the plurality of power consumptions, and the plurality of processing frequency modification decisions, a reward value for the execution of the workload; and modifying one or more weights of the neural network based on the reward value.

### BACKGROUND

System Management Units determine whether to modify the processing frequency and/or voltage of components such as processors. Such System Management Units are tuned by manually selecting particular performance counters as a basis for decision making, using a control system such as a Proportional-Integral-Derivative controller and manually changing various coefficients used in the decision making process until desired performance and power metrics are achieved. This solution is prone to error in selecting the performance counters and is labor intensive due to manual tuning of coefficients and control system parameters.

### BRIEF DESCRIPTION OF THE DRAWINGS

FIG. 1 is a block diagram of an example system for configuring a power management system using reinforcement learning according to some embodiments.

FIG. 2 is a graph of an example non-linear function for configuring a power management system using reinforcement learning according to some embodiments.

FIG. 3 is a flowchart of an example method for configuring a power management system using reinforcement learning according to some embodiments.

FIG. 4 is a flowchart of an example method for configuring a power management system using reinforcement learning according to some embodiments.

FIG. 5 is a flowchart of an example method for configuring a power management system using reinforcement learning according to some embodiments.

### DETAILED DESCRIPTION

In some embodiments, a method of configuring a power management system using reinforcement learning includes: receiving data indicating a plurality of performance characteristics for an execution of a workload, wherein the plurality of performance characteristics include a plurality of processing frequency modification decisions generated by a neural network; calculating, based on one or more of the performance characteristics, a reward value for the execution of the workload; and modifying one or more weights of the neural network based on the reward value.

In some embodiments, receiving the data, and modifying the one or more weights is repeated until a convergence condition is satisfied. In some embodiments, the convergence condition includes one or more of the reward value satisfying a threshold or a degree of variance across a plurality of reward values falling below a threshold. In some embodiments, the plurality of performance characteristics include a plurality of performance counters for execution of the workload and a plurality of power consumptions for execution of the workload. In some embodiments, each of the plurality of performance counters, each of the plurality of power consumptions, and each of the plurality of processing frequency modification decisions corresponds to an interval of a plurality of intervals of execution of the workload. In some embodiments, the plurality of performance counters include one or more of: a percentage of time a component is processing, a data throughput counter, a cache miss counter, and/or a counter indicating that a particular calculation is performed. In some embodiments, the plurality of performance characteristics comprise a performance score for the execution of the workload, and the reward value is calculated based on the performance score and the plurality of power consumptions. In some embodiments, the method further includes providing the neural network to a device configured to adjust processing frequencies based on the neural network. In some embodiments, calculating the reward value includes calculating the reward value based on a non-linear performance function based on a performance loss threshold. In some embodiments, the neural network is configured to accept, as input, one or more normalized performance counters and provide, as output, a processing frequency modification decision comprising one or more of a magnitude of frequency change or a direction of frequency change.

In some embodiments, an apparatus for configuring a power management system using reinforcement learning performs steps including: receiving data indicating a plurality of performance characteristics for an execution of a workload, wherein the plurality of performance characteristics include a plurality of processing frequency modification decisions generated by a neural network; calculating, based on one or more of the performance characteristics, a reward value for the execution of the workload; and modifying one or more weights of the neural network based on the reward value.

In some embodiments, receiving the data, and modifying the one or more weights is repeated until a convergence condition is satisfied. In some embodiments, the convergence condition includes one or more of the reward value satisfying a threshold or a degree of variance across a plurality of reward values falling below a threshold. In some embodiments, the plurality of performance characteristics include a plurality of performance counters for execution of the workload and a plurality of power consumptions for execution of the workload. In some embodiments, each of the plurality of performance counters, each of the plurality of power consumptions, and each of the plurality of processing frequency modification decisions corresponds to an interval of a plurality of intervals of execution of the workload. In some embodiments, the plurality of performance counters include one or more of: a percentage of time a component is processing, a data throughput counter, a cache miss counter, and/or a counter indicating that a particular calculation is performed. In some embodiments, the plurality of performance characteristics comprise a performance score for the execution of the workload, and the reward value is calculated based on the performance score and the plurality of power consumptions. In some embodiments, the steps further include providing the neural network to a device configured to adjust processing frequencies based on the neural network. In some embodiments, calculating the reward value includes calculating the reward value based on a non-linear performance function based on a performance loss threshold. In some embodiments, the neural network is configured to accept, as input, one or more normalized performance counters and provide, as output, a processing frequency modification decision comprising one or more of a magnitude of frequency change or a direction of frequency change.

In some embodiments, a computer program product disposed upon a non-transitory computer readable medium includes computer program instructions for configuring a power management system using reinforcement learning that, when executed, cause a computer system to perform steps including: receiving data indicating a plurality of performance characteristics for an execution of a workload, wherein the plurality of performance characteristics include a plurality of processing frequency modification decisions generated by a neural network; calculating, based on one or more of the performance characteristics, a reward value for the execution of the workload; and modifying one or more weights of the neural network based on the reward value.

In some embodiments, receiving the data, and modifying the one or more weights is repeated until a convergence condition is satisfied. In some embodiments, the convergence condition includes one or more of the reward value satisfying a threshold or a degree of variance across a plurality of reward values falling below a threshold. In some embodiments, the plurality of performance characteristics include a plurality of performance counters for execution of the workload and a plurality of power consumptions for execution of the workload. In some embodiments, each of the plurality of performance counters, each of the plurality of power consumptions, and each of the plurality of processing frequency modification decisions corresponds to an interval of a plurality of intervals of execution of the workload. In some embodiments, the plurality of performance counters include one or more of: a percentage of time a component is processing, a data throughput counter, a cache miss counter, and/or a counter indicating that a particular calculation is performed. In some embodiments, the plurality of performance characteristics comprise a performance score for the execution of the workload, and the reward value is calculated based on the performance score and the plurality of power consumptions. In some embodiments, the steps further include providing the neural network to a device configured to adjust processing frequencies based on the neural network. In some embodiments, calculating the reward value includes calculating the reward value based on a non-linear performance function based on a performance loss threshold. In some embodiments, the neural network is configured to accept, as input, one or more normalized performance counters and provide, as output, a processing frequency modification decision comprising one or more of a magnitude of frequency change or a direction of frequency change.

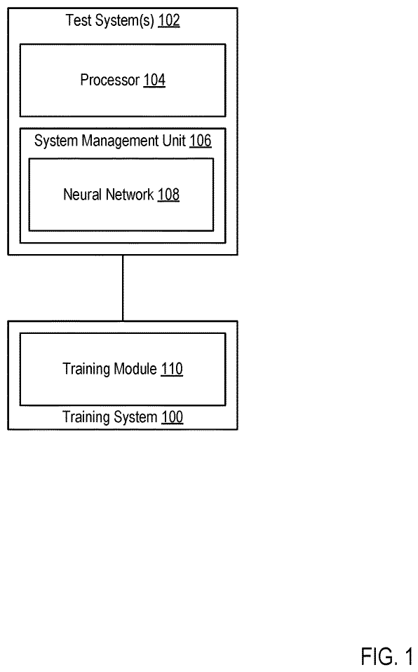

FIG. 1 is a block diagram of a non-limiting system including a training system 100 and one or more test systems 102. The training system 100 and test systems 102 can be implemented using a variety of computing devices or combinations thereof, including personal computers, servers, systems-on-a-chip, composite computing systems, cloud-computing resources, and the like. Each test system 102 includes a processor 104. The processor 104 operates at a processing frequency (e.g., a processing speed) determined by a System Management Unit 106. The System Management Unit 106 is a subsystem that regulates, based on performance and workloads, various attributes of the test system 102, including the processing frequency, voltages, and the like. For example, the System Management Unit 106 determines a particular frequency at which to operate, and selects a corresponding voltage required to drive the processor 104 at that frequency.

Existing solutions for frequency and voltage decision making by a System Management Unit 106 involve manually selecting particular performance counters as a basis for decision making, using a control system and manually changing various coefficients used in the decision making process until desired performance and power metrics are achieved. This solution is prone to error in selecting the performance counters and is labor intensive due to manual tuning of coefficients and control system parameters.

Instead, the System Management Unit 106 uses a neural network 108 to perform frequency and/or voltage decision making. The neural network 108 is an encoded interconnection of nodes or “neurons” that accept data as input and provide an output based on a non-linear function of its inputs. Each neuron in a first layer of the neural network 108 accepts provided input data as input and provides its output to a next layer in the neural network 108. Intermediate layers of the neural network 108 accept, as input, the output of a preceding layer in the neural network 108 and provide their output as input to a next layer in the neural network 108. A last layer in the neural network 108 accepts input from a preceding layer and provides its output as the output of the neural network 108 as a whole. In some embodiments, the neural network 108 accepts, as input, one or more performance counters or normalized performance counters monitored by the System Management Unit 106. Performance counters are trackable metrics of processor 104 and/or system behavior during execution of a workload. Examples of performance counters include a percentage of time a component (e.g., the processor 104) is processing, a data throughput counter, a cache miss counter, and/or a counter of a number of times that a particular calculation is performed. In some embodiments, the neural network 108 provides, as output, a processing frequency modification decision. The processing frequency modification decision is a decision whether to modify the clock frequency of the processor 104 and/or a degree to which the clock frequency should be modified, if any. For example, the output indicates a magnitude of frequency change and/or a direction of frequency change (e.g., increase or decrease of frequency). In some embodiments, the neural network 108 outputs a categorical output, such as a decision whether to increase frequency, decrease frequency, or stay the same. In other embodiments, the neural network 108 outputs a linear output, such as an amount (e.g., magnitude) that the frequency should be changed or a frequency to which the frequency should be changed. As an example, the System Management Unit 106 aggregates performance counters at a predefined interval (e.g., 1 millisecond). The performance counters for a given interval are provided to the neural network 108 to output a processing frequency modification decision. The processing frequency modification decision is then applied to the processor 104.

The neural network 108 is trained by a training module 110 of the training system 100. Training the neural network 108 involves repeatedly providing inputs to the neural network 108 and, based on the provided output, tuning the weights of the neurons in the neural network 108. To train the neural network 108, the training module 110 executes a workload on a test system 102. The workload includes a plurality of tasks, steps, and/or actions to be performed by the test system 102. During execution of the workload, the System Management Unit 106 aggregates performance counters as described above and uses the neural network 108 to determine whether to adjust the frequency of the processor 108. In some embodiments, where the processing frequency modification decision is selected from a plurality of possible decisions (e.g., a “categorical output”) a processing frequency modification decision is selected from a probability distribution generated by the neural network 108, such as a softmax probability distribution. The softmax probability distribution is a function that takes as input a vector z of K real numbers, and normalizes it into a probability distribution consisting of K probabilities proportional to the exponentials of the input numbers. For example, during training of the neural network 108, the processing frequency modification decision is selected randomly from the softmax probability distribution. It is understood that, in some embodiments, after the neural network 108 has been trained and deployed outside of a test or training environment, a processing frequency modification decision is instead selected as a decision having a highest probability output in the distribution. Moreover, it is understood that, in some embodiments, other probability distribution functions are used instead of softmax (e.g., sigmoid). In other embodiments, instead of a categorical output, the neural network 108 outputs a linear output (e.g., a magnitude and direction by which the frequency is modified).

After execution of the workload, the training module 110 receives data indicating one or more performance characteristics for the execution of the workload. In some embodiments, the one or more performance characteristics include a plurality of performance counters for execution of the workload. Performance counters are metrics measured during execution of the workload (e.g., measured of the System Management Unit 106). Examples of performance counters include a percentage of time a component (e.g., the processor 104) is processing during execution of the workload, a data throughput counter, a cache miss counter indicating a number of cache misses during execution of the workload, and/or a counter of a number of times that a particular calculation is performed during execution of the work load. In other words, the determined performance counters are the performance counters used as input to the neural network 108 during a particular interval. In some embodiments, the one or more performance characteristics include a plurality of power consumptions. The power consumptions are power consumptions used by the test system 102 and measured during execution of the workload (e.g., during a particular interval). In some embodiments, the System Management Unit 106 monitors the performance counters and power consumption and provides data indicating the performance counters and the power consumption to the training module 110. In some embodiments, the determined performance counters and the power consumptions may each correspond to a particular interval during execution of the workload.

In some embodiments, the one or more performance characteristics indicated in the data includes a plurality of processing frequency modification decisions generated by the neural network 108 during execution of the workload. Thus, the training module 110 receives, for each interval of execution of the workload, the performance counters provided to the neural network 108, the processing frequency modification decision generated by the neural network, and the power consumption for that interval.

In some embodiments, the one or more performance characteristics indicated in the data includes a performance score for execution of the workload. The performance score is a rating, score, or other quantifiable evaluation of the execution of the workload. For example, in some embodiments, the performance score is a score for a benchmark or stress test performed by the workload.

The training module 110 then calculates a reward value for the execution of the workload. The reward value is calculated using a reward function for reinforcement learning-based training of the neural network 108. The reward function calculates the reward value based on the performance score for the workload. In some embodiments, the power consumption and/or performance score are normalized. In some embodiments, the performance score provides a positive impact on the reward value, while power consumption provides a negative impact on the reward value.

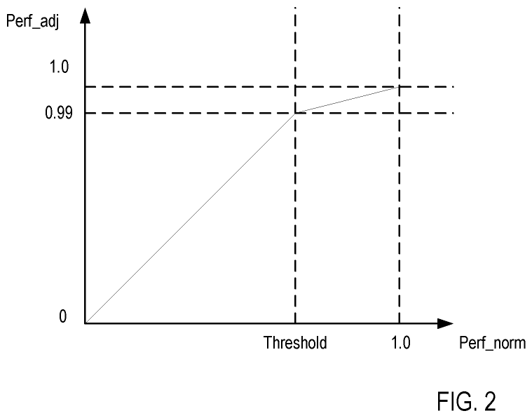

In some embodiments, the reward value is calculated based on a maximum acceptable performance loss such that some decrease in performance is acceptable if power consumption is reduced. For example, in some embodiments an adjusted performance score is calculated using a non-linear performance function based on a performance loss threshold. For example, referring to FIG. 2, Perf_norm represents a normalized performance score while Perf_adj represents an adjusted performance score. As the normalized performance score increases up to a performance loss threshold, the adjusted performance score also increases according to a first slope. Beyond the performance loss threshold, as the normalized performance score increases, the adjusted performance score increases according to a second slope less than the first slope. Accordingly, if as normalized performance score decreases approaching the performance loss threshold, the adjusted performance score decreases at a slower or lesser rate compared to the normalized performance score falling below the performance loss threshold.

As an example, a normalized performance score “Perf_norm” is calculated as “Perf/Max_Perf,” where “Perf” is a performance score and “Max_Perf” is a maximum performance score. An adjusted performance score “Perf_adj” is calculated by applying the non-linear performance function to “Perf_Norm.” A normalized power consumption “Pwr_norm” is calculated as “Power/Max_Power,” where “Power” is a power consumption and “Max_Power” is a maximum power consumption. The reward value is then calculated as “Reward=Perf_adj−β*Pwr_norm,” where β is a scaling coefficient. After calculating the reward value, the training module 110 modifies one or more weights of the neural network 108 based on the reward value. In some embodiments, using back-propagation, gradients of the neural network 108 are modulated based on the reward value and applied to the weights of the neural network 108. For example, the weights of the neural network 108 are modified using the following formula: “θ←θ−(α*(∂J(X, y,θ))/∂θ)*Reward” where θ represents the weights of the neural network, X is the set of input variables (e.g., the performance counters), y is the frequency decision output by the neural network 108 during training, Reward is the calculated reward value, and J is the cost function. This formula updates θ by the gradient*reward, where gradient is the partial derivative of the cost function with respect to the various weights (e.g., θs).

In some embodiments, the training module 110 repeats the process of causing the test system 110 to execute a workload, calculate a reward value, and modifying the weights of the neural network 108. In some embodiments, each iteration uses a different workload or is selected from a plurality of workloads. In some embodiments, the plurality of workloads include actual workloads and/or artificial workloads. The process is repeated until a convergence condition is met, indicating that the neural network 108 is trained. In some embodiments, the convergence condition is the reward value meeting a threshold. In other embodiments, the convergence condition is a degree in variance of the reward value across iterations falling below a threshold. In other embodiments, the convergence condition is a predefined number of iterations being performed.

In some embodiments, the trained neural network 108 is then provided to a device (e.g., System Management Units 106 of other processors 104). For example, in some embodiments, the trained neural network 108 is installed or stored on the device at manufacture. In other embodiments, the trained neural network 108 is provided over a network and installed on the device (e.g., as part of a software or firmware update).

Although the training module 110 is discussed as training a neural network 108, it is understood that the approaches described above are applicable to any control system tuned based on a gradient descent approach, including Linear Regression. Accordingly, in some embodiments the neural network 108 is replaced with another trainable control system.

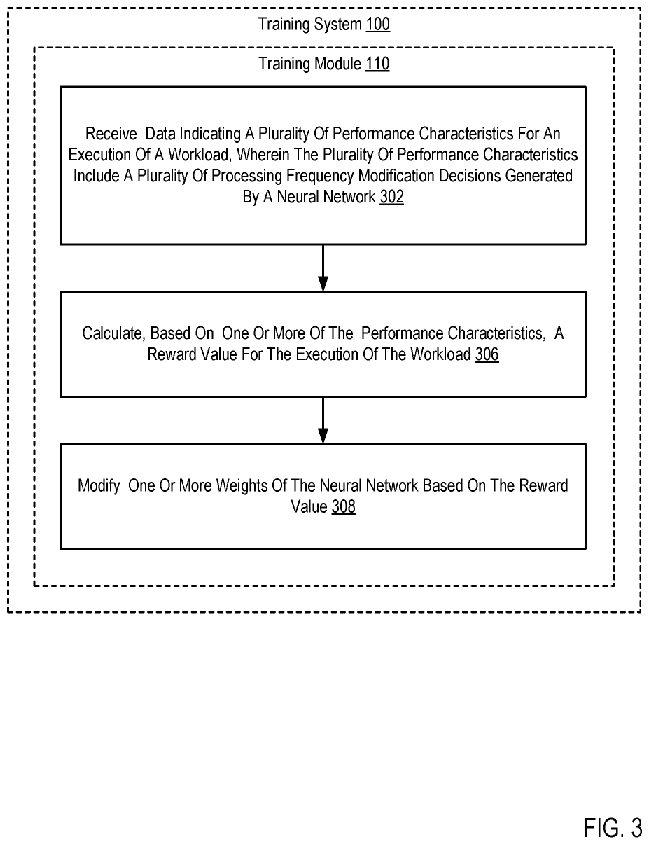

For further explanation, FIG. 3 sets forth a flow chart illustrating an exemplary method for configuring a power management system using reinforcement learning that includes receiving 302 (e.g., by a training module 110 of a training system 100) data indicating a plurality of performance characteristics for an execution of a workload by a system (e.g., a test system 102), wherein the plurality of performance characteristics include a plurality of processing frequency modification decisions generated by a neural network 108. In some embodiments, the performance counters includes a plurality of performance counters. Examples of performance counters include a percentage of time a component (e.g., the processor 104) is processing, a data throughput counter, a cache miss counter, and/or a counter of a number of times that a particular calculation is performed. In some embodiments, the plurality of performance characteristics includes a plurality of power consumptions for execution of the workload. The power consumptions are an amount of power consumed to execute the workload (e.g., during a particular interval).

The neural network 108 is implemented by a power management system of the system executing the workload. For example, a System Management Unit 106 implements the neural network to generate the processing frequency modification decision. In some embodiments, the processing frequency modification decision includes a determination whether to increase or reduce the processing frequency of a processor 104, or to leave the processing frequency unchanged. In other embodiments, the processing frequency modification decision indicates a magnitude and/or direction for changing the processing frequency. In some embodiments, a processing frequency modification decision is selected from a probability distribution generated by the neural network 108, such as a softmax probability distribution. For example, the decision is selected randomly from the softmax probability distribution. In some embodiments, the data is received 302 from a component of the system executing or maintaining the neural network 108 (e.g., from a System Management Unit 106 of the system).

In some embodiments, the plurality of performance characteristics includes a performance score for execution of the workload. The performance score is a rating, score, or other quantifiable evaluation of the execution of the workload. For example, in some embodiments, the performance score is a score for a benchmark or stress test performed by the workload.

The method of FIG. 3 also includes calculating 306, based on one or more of the performance characteristics, a reward value for the execution of the workload. The reward value is calculated using a reward function for reinforcement learning-based training of the neural network 108. The reward function calculates the reward value based on the performance score and the plurality of power consumptions. In some embodiments, the power consumption and/or performance score are normalized. In some embodiments, the performance score provides a positive impact on the reward value, while power consumption provides a negative impact on the reward value.

In some embodiments, the reward value is calculated based on a maximum acceptable performance loss such that some decrease in performance is acceptable if power consumption is reduced. For example, in some embodiments an adjusted performance score is calculated using a non-linear performance function based on a performance loss threshold. For example, referring to FIG. 2, Perf_norm represents a normalized performance score while Perf_adj represents an adjusted performance score. As the normalized performance score increases up to a performance loss threshold, the adjusted performance score also increases according to a first slope. Beyond the performance loss threshold, as the normalized performance score increases, the adjusted performance score increases according to a second slope less than the first slope. Accordingly, if as normalized performance score decreases approaching the performance loss threshold, the adjusted performance score decreases at a slower or lesser rate compared to the normalized performance score falling below the performance loss threshold.

As an example, a normalized performance score “Perf_norm” is calculated as “Perf/Max_Perf,” where “Perf” is a performance score and “Max_Perf” is a maximum performance score. An adjusted performance score “Perf_adj” is calculated by applying the non-linear performance function to “Perf_Norm.” A normalized power consumption “Pwr_norm” is calculated as “Power/Max_Power,” where “Power” is a power consumption and “Max_Power” is a maximum power consumption. The reward value is then calculated as “Reward=Perf_adj−β*Pwr_norm,” where β is a scaling coefficient.

The method of FIG. 3 also includes modifying 308 one or more weights of the neural network 108 based on the reward value. In some embodiments, using back-propagation, gradients of the neural network 108 are modulated based on the reward value and applied to the weights of the neural network 108. For example, the weights of the neural network 108 are modified using the following formula: “θ←θ−(α*(∂J(X, y,θ))/∂θ)*Reward” where θ represents the weights of the neural network, X is the set of input variables (e.g., the performance counters), y is the frequency decision output by the neural network 108 during training, Reward is the calculated reward value, and J is the cost function. This formula updates θ by the gradient*reward, where gradient is the partial derivative of the cost function with respect to the various weights (e.g., θs).

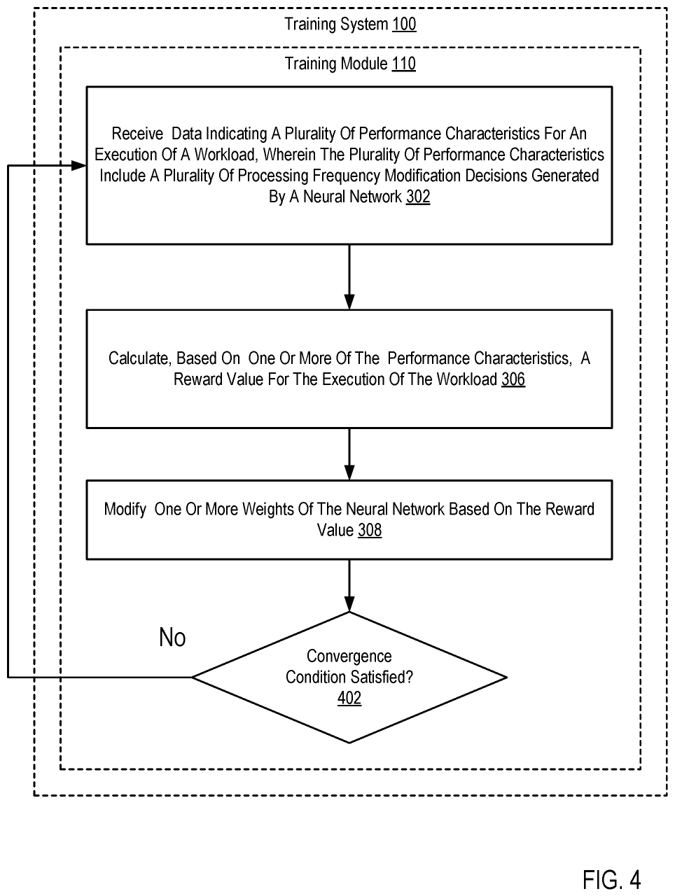

For further explanation, FIG. 4 sets forth a flow chart illustrating an exemplary method for configuring a power management system using reinforcement learning that includes receiving 302 (e.g., by a training module 110 of a training system 100) data indicating a plurality of performance characteristics for an execution of a workload, wherein the plurality of performance characteristics include a plurality of processing frequency modification decisions generated by a neural network 108; calculating 306, based on one or more of the performance characteristics, a reward value for the execution of the workload; and modifying 308 one or more weights of the neural network 108 based on the reward value.

The method of FIG. 4 differs from FIG. 3 in that the method of FIG. 4 includes determining 402 whether a convergence condition is satisfied. In some embodiments, the convergence condition is the reward value meeting a threshold. In other embodiments, the convergence condition is a degree in variance of the reward value across iterations falling below a threshold. In other embodiments, the convergence condition is a predefined number of iterations being performed. If the convergence condition is satisfied, the neural network 108 is considered trained. If the convergence condition is not satisfied, the method returns to receiving 302 the data. Thus, the method of FIG. 4 repeats until the convergence condition is satisfied and the neural network 108 is trained.

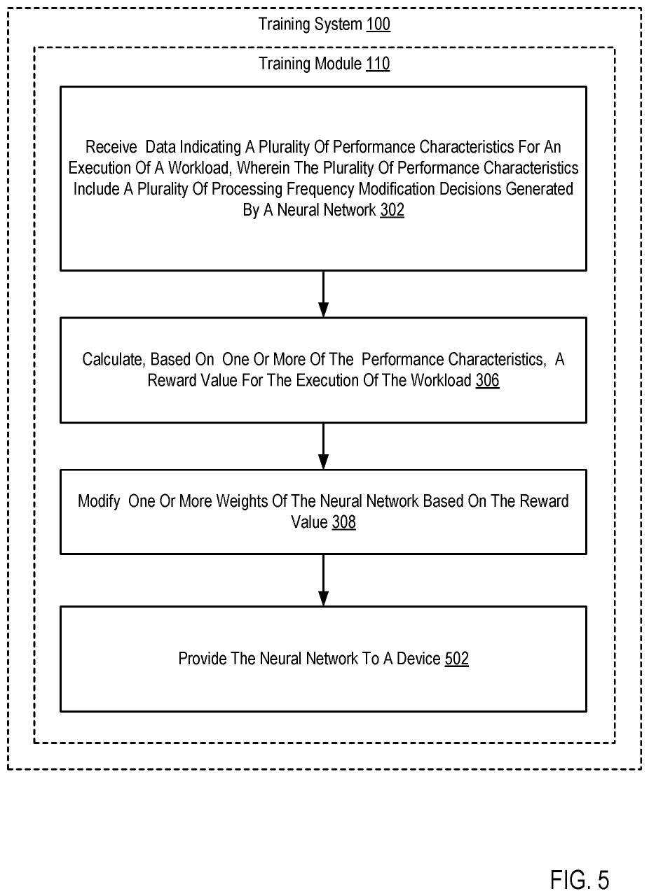

For further explanation, FIG. 5 sets forth a flow chart illustrating an exemplary method for configuring a power management system using reinforcement learning that includes receiving 302 (e.g., by a training module 110 of a training system 100) data indicating a plurality of performance characteristics for an execution of a workload, wherein the plurality of performance characteristics include a plurality of processing frequency modification decisions generated by a neural network 108; calculating 306, based on one or more of the performance characteristics, a reward value for the execution of the workload; and modifying 308 one or more weights of the neural network 108 based on the reward value.

The method of FIG. 5 differs from FIG. 3 in that the method of FIG. 5 also includes providing 502 the neural network 108 (e.g., the trained neural network 108) to a device (e.g., System Management Units 106 of other processors 104). For example, in some embodiments, the trained neural network 108 is installed or stored on the device at manufacture. In other embodiments, the trained neural network 108 is provided over a network and installed on the device (e.g., as part of a software or firmware update).

In view of the explanations set forth above, readers will recognize that the benefits of configuring a power management system using reinforcement learning include:
Improved performance of a computing system by training a neural network to make frequency modification decisions without the need for manually tuning a control system.

Exemplary embodiments of the present disclosure are described largely in the context of a fully functional computer system for configuring a power management system using reinforcement learning. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

What is claimed is:

1. A method of configuring a power management system using reinforcement learning, the method comprising:
receiving data indicating a plurality of performance characteristics for an execution of a workload, wherein the plurality of performance characteristics include a plurality of processing frequency modification decisions generated by a neural network;
calculating, based on one or more of the performance characteristics, a reward value for the execution of the workload; and
modifying one or more weights of the neural network based on the reward value.

2. The method of claim 1, wherein receiving the data, calculating the reward value, and modifying the one or more weights is repeated until a convergence condition is satisfied.

3. The method of claim 2, wherein the convergence condition comprises one or more of the reward value satisfying a threshold or a degree of variance across a plurality of reward values falling below a threshold.

4. The method of claim 1, wherein the plurality of performance characteristics include a plurality of performance counters for execution of the workload and a plurality of power consumptions for execution of the workload.

5. The method of claim 4, wherein each of the plurality of performance counters, each of the plurality of power consumptions, and each of the plurality of processing frequency modification decisions corresponds to an interval of a plurality of intervals of execution of the workload.

6. The method of claim 4, wherein the plurality of performance counters comprise one or more of: a percentage of time a component is processing, a data throughput counter, a cache miss counter, and/or a counter indicating that a particular calculation is performed.

7. The method of claim 4, wherein the plurality of performance characteristics comprise a performance score for the execution of the workload, and the reward value is calculated based on the performance score and the plurality of power consumptions.

8. The method of claim 1, further comprising providing the neural network to a device configured to adjust processing frequencies based on the neural network.

9. The method of claim 1, wherein calculating the reward value comprises calculating the reward value based on a non-linear performance function based on a performance loss threshold.

10. The method of claim 1, wherein the neural network is configured to accept, as input, one or more normalized performance counters and provide, as output, a processing frequency modification decision comprising one or more of a magnitude of frequency change or a direction of frequency change.

11. An apparatus for configuring a power management system using reinforcement learning, the apparatus configured to perform steps comprising:
receiving data indicating a plurality of performance characteristics for an execution of a workload, wherein the plurality of performance characteristics include a plurality of processing frequency modification decisions generated by a neural network;
calculating, based on one or more of the performance characteristics, a reward value for the execution of the workload; and
modifying one or more weights of the neural network based on the reward value.

12. The apparatus of claim 11, wherein receiving the data, calculating the reward value, and modifying the one or more weights is repeated until a convergence condition is satisfied.

13. The apparatus of claim 12, wherein the convergence condition comprises one or more of the reward value satisfying a threshold or a degree of variance across a plurality of reward values falling below a threshold.

14. The apparatus of claim 11, wherein the plurality of performance characteristics include a plurality of performance counters for execution of the workload and a plurality of power consumptions for execution of the workload.

15. The apparatus of claim 14, wherein each of the plurality of performance counters, each of the plurality of power consumptions, and each of the plurality of processing frequency modification decisions corresponds to an interval of a plurality of intervals of execution of the workload.

16. The apparatus of claim 14, wherein the plurality of performance counters comprise one or more of: a percentage of time a component is processing, a data throughput counter, a cache miss counter, and/or a counter indicating that a particular calculation is performed.

17. The apparatus of claim 14, wherein the plurality of performance characteristics comprise a performance score for the execution of the workload, and the reward value is calculated based on the performance score and the plurality of power consumptions.

18. The apparatus of claim 11, wherein the steps further comprise providing the neural network to a device configured to adjust processing frequencies based on the neural network.

19. The apparatus of claim 11, wherein calculating the reward value comprises calculating the reward value based on a non-linear performance function based on a performance loss threshold.

20. The apparatus of claim 11, wherein the neural network is configured to accept, as input, one or more normalized performance counters and provide, as output, a processing frequency modification decision comprising one or more of a magnitude of frequency change or a direction of frequency change.

21. A computer program product disposed upon a non-transitory computer readable medium, the computer program product comprising computer program instructions for configuring a power management system using reinforcement learning that, when executed, cause a computer system to perform steps comprising:
receiving data indicating a plurality of performance characteristics for an execution of a workload, wherein the plurality of performance characteristics include a plurality of processing frequency modification decisions generated by a neural network;
calculating, based on one or more of the performance characteristics, a reward value for the execution of the workload; and
modifying one or more weights of the neural network based on the reward value.

22. The computer program product of claim 21, wherein receiving the data, calculating the reward value, and modifying the one or more weights is repeated until a convergence condition is satisfied.

23. The computer program product of claim 22, wherein the convergence condition comprises one or more of the reward value satisfying a threshold or a degree of variance across a plurality of reward values falling below a threshold.

24. The computer program product of claim 21, wherein the plurality of performance characteristics include a plurality of performance counters for execution of the workload and a plurality of power consumptions for execution of the workload.

25. The computer program product of claim 24, wherein each of the plurality of performance counters, each of the plurality of power consumptions, and each of the plurality of processing frequency modification decisions corresponds to an interval of a plurality of intervals of execution of the workload.

26. The computer program product of claim 24, wherein the plurality of performance counters comprise one or more of: a percentage of time a component is processing, a data throughput counter, a cache miss counter, and/or a counter indicating that a particular calculation is performed.

27. The computer program product of claim 24, wherein the plurality of performance characteristics comprise a performance score for the execution of the workload, and the reward value is calculated based on the performance score and the plurality of power consumptions.

28. The computer program product of claim 21, wherein the steps further comprise providing the neural network to a device configured to adjust processing frequencies based on the neural network.

29. The computer program product of claim 21, wherein calculating the reward value comprises calculating the reward value based on a non-linear performance function based on a performance loss threshold.

30. The computer program product of claim 21, wherein the neural network is configured to accept, as input, one or more normalized performance counters and provide, as output, a processing frequency modification decision comprising one or more of a magnitude of frequency change or a direction of frequency change.
